(19) United States
(12) Patent Application Publication
(10) Pub. No.: US 2025/0290866 A1
(43) Pub. Date: Sep. 18, 2025

(54) MONITORING DEVICE, LOADING SYSTEM, FREEZE-DRYER SYSTEM AND METHOD

(71) Applicant: Groninger & Co. GmbH, Crailsheim (DE)

(72) Inventors: Armin MERZ, Ellwangen (DE); Matthias METTMANN, Ellenberg (DE)

(21) Appl. No.: 19/225,418

(22) Filed: Jun. 2, 2025

Related U.S. Application Data
(63) Continuation of application No. PCT/EP2023/082359, filed on Nov. 20, 2023.

(30) Foreign Application Priority Data
Dec. 2, 2022 (DE) 10 2022 132 062.6

(51) Int. Cl. G01N 21/90; B07C 5/34; B07C 5/342; F26B 5/06; F26B 25/00

(52) U.S. Cl. CPC G01N 21/90; B07C 5/3404; B07C 5/3422; F26B 5/06; F26B 25/001; B07C 2501/0063

(57) ABSTRACT

A monitoring device for monitoring at least one container, filled with a freeze-dried product, at a monitoring position, wherein the monitoring device has a handling means, a camera system, and a control means. The camera system is arranged in a vertical direction below the monitoring position, the handling means is configured to arrange the container at the monitoring position, the camera system is configured to capture an image of the container at the monitoring position, and the control means is configured to determine, on the basis of the captured image, whether the container has a defect. A loading system for a freeze dryer, a freeze-dryer system, and a method for monitoring at least one container, which is filled with a freeze-dried product at a monitoring position, are also disclosed.

### CROSS-REFERENCE TO RELATED APPLICATIONS

This is a Continuation application of International patent application PCT/EP2023/082359, filed Nov. 20, 2023, which claims the priority of German patent application DE 10 2022 132 062.6, filed Dec. 2, 2022 Both applications PCT/EP2023/082359 and DE 10 2022 132 062.6 are herewith incorporated by reference in their entireties.

### FIELD

The present invention generally relates to a monitoring device for monitoring at least one container filled with a freeze-dried product at a monitoring position, to a loading system for a freeze dryer, and to a freeze-dryer system comprising such a loading system and a freeze dryer.

### BACKGROUND

When packaging medical, pharmaceutical or cosmetic products or substances, it is common practice to meter these products into containers and then seal them. For example, vials, cartridges, cylindrical ampoules, bottles, syringes, and the like can be used as containers.

Known packaging machines for packaging these products have a filling station in which the containers are filled with the product, a stoppering station in which a stopper is placed on the containers, and a crimp-capping station in which each container is closed with a crimp cap. The entire packaging process of the products is carried out in a controlled, preferably aseptic, environment. In particular, a barrier system can be used to provide the controlled environment.

A barrier system is to be understood as a system that provides a physical and aerodynamic barrier, e.g. by means of positive air pressure, between an external environment, for example an external cleanroom environment, and a work process. In particular, a barrier system is used to provide an environment with restricted access, in which the work process can be carried out. Various barrier systems are known in the prior art. A barrier system may, for example, include an isolator or a barrier with restricted access, a so-called RABS (restricted area barrier system). The RABS can be an open RABS or a closed RABS.

In packaging machines of this type, it is also known to provide a freeze-drying station between the filling station and the crimp-capping station, in which the product in the containers can be freeze-dried.

Freeze-drying, also known as lyophilizing, lyophilization or sublimation drying, is a method for the gentle drying of products. Freeze-drying is based on the physical process of sublimation. Here, the ice crystals sublimate directly into the gaseous state without the intermediate appearance of a liquid phase. The final product of freeze-drying is called lyophilizate. Freeze-drying is used in particular for thermally sensitive products.

Freeze-drying is used in particular for drying pharmaceutical products. The pharmaceutical industry uses this method to dry drugs that would not be stable for long if dissolved in water. Before the medication is taken, it is dissolved in water again.

For freeze-drying, the containers filled with the product are placed in a freeze dryer, which carries out the freeze-drying. The freeze dryer can, for example, have a plurality of shelves on different levels, each of which can hold several containers.

Loading systems for freeze dryers and freeze-dryer systems are known in the prior art.

For example, document DE 10 2020 118 726 A1 shows a loading system for a freeze dryer, wherein the loading system is designed to load the freeze dryer with containers filled with a medical, pharmaceutical or cosmetic substance and/or unload them, wherein the loading system has a handling station and at least one carrier plate, wherein each carrier plate has a plurality of receptacles which are designed to receive in each case one of the containers, wherein the handling station has at least one handling means which is designed to handle the carrier plate in the handling station. Furthermore, document DE 10 2020 118 726 A1 shows a freeze-drying system with such a loading system. Furthermore, document DE 10 2020 118 726 A1 shows a method for handling containers filled with a medical, pharmaceutical or cosmetic substance in such a loading system for a freeze dryer.

In such freeze-dryer systems, containers filled with a medical, pharmaceutical or cosmetic product are first fed into the loading system. By means of a handling means at a loading station of the loading system the containers can then be inserted into the receptacles of a carrier plate. Once the carrier plates have been loaded with the containers, the carrier plates can be inserted into the freeze dryer by means of a handling means. The containers or the product they contain are then freeze-dried in the freeze dryer. After freeze-drying, the carrier plates can be removed from the freeze dryer. The containers can then be removed from the receptacles of the carrier plate by means of a handling means and transferred to a transfer station.

The problem with such freeze-dryer systems is that the containers may come out of the freeze-dryer damaged. In particular, the bottom of the containers may be damaged. During the return of a damaged container to a transfer station, the damaged container may fall over or break. This results in the loading system or the environment in which the loading system is located being contaminated with the product from the damaged container and/or with glass fragments from the damaged container. This creates a risk of product cross-contamination. This can in particular lead to a machine stop. Furthermore, glass splinters or the escaping product can damage tools or machine parts.

Furthermore, devices are also known in the prior art by means of which containers or products contained therein can be monitored.

For example, document DE 10 2014 016 135 A1 shows a monitoring device for detecting defective products in production processes such as those used in the pharmaceuticals filling industry. Document DE 10 2014 016 135 A1 also shows an inspection system with an inspection device and a corresponding inspection method.

Furthermore, document WO 2020/027923 A1 shows a robot inspection platform comprising a robot arm, an imager and a controller. The controller causes the robot arm, using its end effector, to retrieve a container and manipulate the container to sequentially place the container in a variety of orientations while in the field of view of the imager. The controller also causes the imager to capture images, with each of the images being captured while the container is in a corresponding orientation. The controller also determines one or more attributes of the container and/or of a sample within the container by analyzing the images using a pattern recognition model and, on the basis of the attribute(s), determines whether the container and/or sample meets one or more criteria. If the container and/or sample do not meet the criteria, the controller causes the robot arm to place the container in an area (e.g. container) reserved for rejected containers and/or samples.

However, known packaging machines still leave room for improvement, particularly with regard to the monitoring and processing of the containers.

### SUMMARY

Against this background, it is an object of the present application to provide an improved monitoring device, an improved loading system and an improved freeze-dryer system in which in particular the monitoring and processing of the containers is improved.

According to a first aspect, a monitoring device for monitoring at least one container filled with a freeze-dried product at a monitoring position is provided, wherein the monitoring device has a handling means, a camera system and a control means, wherein the camera system is arranged in a vertical direction below the monitoring position, wherein the handling means is configured to arrange the container at the monitoring position, wherein the camera system is configured to capture an image of the container at the monitoring position, and wherein the control means is configured to determine, on the basis of the captured image, whether the container has a defect.

In a second aspect, a loading system for a freeze dryer is provided, wherein the loading system comprises a loading station for loading the freeze dryer with containers filled with a pharmaceutical or cosmetic product and/or unloading them, and the monitoring device according to the first aspect.

In a third aspect, a freeze-dryer system is provided, comprising a freeze dryer and the loading system according to the second aspect.

In a fourth aspect, a method is provided for monitoring at least one container filled with a freeze-dried product at a monitoring position, wherein a camera system is arranged in a vertical direction below the monitoring position, wherein the method comprises the following steps:
arranging the container at the monitoring position by means of a handling means;
capturing an image of the container at the monitoring position by means of the camera system; and
determining, on the basis of the captured image, whether the container has a defect.

The method according to the fourth aspect can be carried out by means of the monitoring device according to the first aspect. In particular, the method according to the fourth aspect can be carried out in the loading system according to the second aspect or in the freeze-dryer system according to the third aspect.

The containers may be, for example, a vial, a carpule, a cylindrical ampoule, a bottle, a syringe, or the like. In particular, the containers can be vials. The containers can preferably be cylindrical or have a circular cross-section. The shape of each container can in particular be rotationally symmetrical with respect to an axis of symmetry. The product with which the containers are filled may preferably be a cosmetic or pharmaceutical product. The product is freeze-dried before being monitored. The product can be freeze-dried in the freeze dryer. For this purpose, the containers filled with the product can be arranged in the freeze dryer.

The monitoring device and the loading system can be arranged within a freeze-drying module. The freeze-drying module may have an interior space. The interior space of the freeze-drying module may be provided as a controlled, preferably aseptic, environment. In particular, a barrier system can be used to provide the controlled environment. The barrier system can be, for example, an isolator, an open RABS or a closed RABS. The freeze-dryer system may include the freeze-drying module. The freeze dryer can be arranged outside the freeze-drying module. The freeze-drying module may have a port, wherein the freeze dryer may be arranged externally at the port. The freeze dryer can be coupled to the port, in particular from the outside. Alternatively, the freeze dryer can also be arranged within the freeze-drying module. The freeze-dryer system can in particular be part of a packaging machine for packaging the pharmaceutical or cosmetic product. The packaging machine or freeze-dryer system may comprise the barrier system.

The freeze dryer can be loaded with containers and/or unloaded by means of the loading system. For this purpose, the loading system comprises the loading station. The loading station is preferably arranged within the freeze-drying module. The loading station can in particular be arranged on the freeze dryer. In particular, the loading station can be arranged at the port of the freeze-drying module.

One or more carrier plates can be used to load and unload containers into/out of the freeze dryer. Each carrier plate has a plurality of receptacles. The receptacles of the carrier plate are designed so that each receptacle can hold one container. In particular, the receptacles can be formed as depressions in a surface of the carrier plate. The containers can in particular be placed in the receptacles on the plate. The carrier plate can, for example, be made of a plastic.

One or more carrier plates can be loaded with containers in the loading station. For this purpose, the containers can be arranged in the receptacles of the carrier plates. The loaded carrier plates can then be introduced into the freeze dryer. After freeze-drying, the carrier plates can then be removed from the freeze dryer. In the loading station, the containers can then be removed from the receptacles. The loading station has a loading surface on which the carrier plates can be arranged for loading and unloading the containers. The freeze dryer may have one or more shelves on which the carrier plates can be arranged in the freeze dryer.

The loading system may comprise a further handling means which is designed to introduce the carrier plates into the freeze dryer or to remove them therefrom. In particular, the further handling means can be configured to move a carrier plate from the loading area onto one of the storage areas, in particular to push it, or to move the carrier plate from the storage area onto the loading area, in particular to pull it.

After freeze-drying, one or more containers can be monitored by means of the monitoring device. Preferably, the monitoring device can monitor several containers one after the other. The monitoring takes place at a monitoring position. The monitoring position is a specific location in space. The monitoring position is preferably located within the freeze-drying module. In particular, the monitoring position can be arranged near the loading station.

The containers can be handled by means of the handling means. In particular, a container can be arranged at the monitoring position by means of the handling means. For example, the handling means can transfer the container to be monitored to the monitoring position. For this purpose, the handling means can pick up the container, in particular grip it, and move or transfer it to the monitoring position. During the movement or transfer, the handling means can hold the container firmly. In particular, the handling means can hold the container at the monitoring position. The handling means can be designed as a handling robot. The handling means may, for example, comprise a multi-axis arm and an end effector. The end effector is arranged at one end of the arm. The end effector can be moved by means of the arm. For example, a drive device can be provided to move the arm. The end effector may comprise a gripping device, in particular one or more grippers. By means of the gripping device, at least one container, in particular one container per gripper, can be picked up or gripped and then moved, in particular transferred.

The camera system of the monitoring device is arranged in such a way that it can capture or record an image in which the monitoring position is shown. For image capture, the camera system may, for example, comprise a camera or an optical sensor, in particular a CCD sensor or CMOS sensor. The camera system is arranged in a vertical direction below the monitoring position and facing the monitoring position. In particular, the camera system can be arranged in space at a fixed position and in a fixed orientation.

To monitor the container, the container is placed at the monitoring position by means of the handling means and the camera system captures an image of the container at the monitoring position. Since the camera system is located below the monitoring position, the captured image shows the container from below. On the basis of the captured image, it can then be determined whether the container has a defect.

The control means of the monitoring device can control the handling means and the camera system. In particular, the control means can control the handling of the containers by the handling means and the image capture of the camera system. In particular, the control means can control the handling means in such a way that the handling means arranges the container at the monitoring position. Furthermore, the control means can control the camera system in such a way that the camera system captures an image of the container at the monitoring position.

The control means can also evaluate the captured image. In particular, the control means can determine, on the basis of the captured image, whether the container has a defect. On the basis of the evaluation of the captured image, appropriate measures can then be taken. If the monitoring reveals that the container is defective, the container can for example be rejected. If the monitoring shows that the container is not defective, the container can for example be further processed.

By means of the new monitoring device, the containers can be monitored after freeze-drying. Defective or damaged containers can thereby be identified and rejected after freeze-drying. This prevents a damaged container from falling over or breaking when it is being returned to a transfer station. In this way, the processing and monitoring of the containers is improved. In particular, this improves the functional reliability and operational safety of the freeze-dryer system, especially of the packaging machine.

In a first refinement of the aspects, the handling means can be configured to transfer the container to a transfer station when the container has no defect.

In particular, the control means can be configured to control the handling means in such a way that the container is transferred to a transfer station when the container has no defect. In particular, the handling means can transfer the monitored container to the transfer station when the monitoring has shown that the container has no defect. The transfer station can be used to transfer containers to downstream processing stations. Ensuring that only containers without defects are transferred to the transfer station prevents defective containers from being able to reach the transfer station or downstream processing stations. The loading system or the freeze-dryer system may include the transfer station. Alternatively, the transfer station can be arranged adjacent to the loading system. The transfer station can, for example, have a container holder. The container holder can, for example, have one or more receptacles, each receptacle being able to accommodate a container.

In a further refinement of the aspects, the handling means can be configured to transfer the container to a disposal device if the container has a defect.

In particular, the control means can be configured to control the handling means in such a way that the container is transferred to a disposal device if the container has a defect. In particular, the handling means may transfer the monitored container to the disposal device if the monitoring reveals that the container has a defect. In this way, defective containers are rejected after freeze-drying. This prevents defective containers from being further processed and, in particular, from reaching downstream processing stations. The loading system or the freeze-dryer system may include the disposal device. The disposal device is used to dispose of defective containers. The disposal device may be located within the controlled environment. The disposal device may include a collection container. The collection container is used to collect the defective containers. In order to dispose of the containers, the containers can for example be collected in the collection container.

In a further refinement of the aspects, the handling means can be configured to arrange the container at the monitoring position in a defined orientation.

In particular, the control means can be configured to control the handling means in such a way that the handling means arranges the container at the monitoring position in a defined orientation. The defined orientation can be an orientation in space. As a result, the relative arrangement of the container, in particular the position and orientation of the container, relative to the camera system is determined in advance. The container is thereby shown in a predetermined image region of the captured image. In particular, the position of the container, in particular the position of individual regions or features of the container, is known in advance by the arrangement of the container at the monitoring position in the defined orientation. In particular, individual features or regions of the container can be easily monitored as a result.

In a further refinement of the aspects, the container may have a bottom, wherein the handling means is configured to arrange the container at the monitoring position such that the bottom faces the camera system.

In particular, the control means can be configured to control the handling means in such a way that the container is arranged at the monitoring position so that the bottom faces the camera system. In this way, the bottom of the container is shown in the captured image. This allows the bottom of the container to be checked for defects. The bottom may be oriented downwards, particularly in the vertical direction. In particular, the container is oriented vertically at the monitoring position. In other words, the defined orientation of the container is a vertical orientation. Since the camera system is located below the monitoring position, the bottom is thus facing the camera system. The container may comprise the bottom and an opening. A stopper may be inserted into the opening. The opening and the bottom are located on opposite ends of the container. The container can be arranged, in particular held, at the monitoring position by means of the handling means in such a way that the opening is arranged at the top and the bottom at the bottom with respect to the vertical direction.

In a further refinement of the aspects, the control means can be configured to determine, on the basis of the captured image, whether the bottom of the container has a defect.

In order to determine whether the bottom of the container has a defect, the control means can, for example, evaluate the captured image. For this purpose, the captured image can, for example, be compared with a reference image in which the bottom of an undamaged container is shown at the monitoring position. The container may have defects such as cracks, dents, holes or breakouts on its bottom. These can occur both at the edge of the bottom and in the middle of the bottom. In particular, the control means can determine, on the basis of the captured image, whether the bottom has one or more of these defects. Furthermore, the bottom of the container may be completely broken off or completely missing. In particular, on the basis of the captured image the control means can determine whether the bottom is present or missing.

In a further refinement of the aspects, the container may have an annular projection on the bottom, wherein the control means is configured to determine, based on the captured image, whether the annular projection is complete, and wherein the control means is configured to determine that the container has a defect if the annular projection is not complete.

The bottom of the vial may have a circular depression or indentation. In other words, the bottom of the vial may be curved inwards. The bottom thus has a ring-shaped region around the circular depression, which serves as a base when the vial is placed with its bottom on a flat surface. This ring-shaped region can also be called an annular projection. The control means can determine in the captured image whether the annular projection of the bottom, depicted therein, is complete. During freeze-drying, thermal or mechanical stresses may occur in the container. At the bottom of the container, these can be greatest in the region of the annular projection. If the bottom has been damaged during freeze-drying, the annular projection will usually no longer be complete. For example, the annular projection may have defects such as cracks, holes, gaps, or chipped or missing locations. This can be monitored in the captured image. In particular, it can be determined whether the annular projection shown in the captured image is closed and homogeneous, in particular with no interruptions circumferentially. The control means can then determine that the container has a defect if the annular projection is not complete. Accordingly, the control means can also determine that the container has no defect if the annular projection is complete. This improves the monitoring of the container. Due to the arrangement of the container at the monitoring position in a vertical orientation, the position of the annular projection in the captured image can be known in advance. In particular, the image region of the image in which the annular projection is shown can be known in advance. The control means can then evaluate the corresponding image region for monitoring the annular projection.

In a further refinement of the aspects, the monitoring device may further comprise an illumination device for illuminating the container at the monitoring position, wherein the illumination device is arranged in the vertical direction below the monitoring position, in particular wherein the illumination device is configured to illuminate the bottom of the container at the monitoring position.

The illumination device is arranged in such a way that it illuminates the container at the monitoring position from below. The illumination device can in particular illuminate the bottom of the container. The control means can also control the illumination device. In particular, the control means can control the illumination device in such a way that the container is illuminated at the monitoring position at least during image acquisition by the camera system. In other words, the illumination can be switched on at least during the image acquisition or for the duration of the image acquisition. Alternatively, the illumination can also be switched on for longer, especially permanently. By illuminating the container at the monitoring position, image capture by the camera system can be carried out under defined lighting conditions and with better illumination of the container. This allows defects in the captured image to be better identified.

In a further refinement of the aspects, the illumination device can have an annular light.

The illumination by means of an annular light results in the bottom of the container, in particular the annular projection, being illuminated homogeneously or evenly. Due to the homogeneous illumination, defects such as cracks, dents, breakouts and holes can be detected better and more accurately. This improves the monitoring of the container. In particular, defects on the bottom of the container, especially on the annular projection, or even a completely missing bottom can be better detected thereby. Since the container preferably has a rotationally symmetrical shape and the container is homogeneously illuminated by the ring light, the image of the annular projection should be essentially the same in the peripheral direction around the axis of symmetry. Deviations in individual regions of the annular projection can thus be detected and determined particularly easily and accurately.

In particular, the annular light can have a base body, preferably annular. The annular light may have a cylindrical recess in the base body that extends through the base body. The base body may have a plurality of lighting elements, in particular a plurality of light-emitting diodes. The lighting elements can be arranged around the recess, preferably evenly distributed or distributed peripherally at equal distances. The lighting elements can in particular be arranged on a side of the base body facing the monitoring position. The recess may extend through the base body from the side facing the monitoring position to a side facing away from the monitoring position. The camera system is preferably arranged below the illumination device. The camera system can be arranged on the side of the base body facing away from the monitoring position. The illumination device can thus be arranged between the camera system and the monitoring position. In particular, the camera system can detect the monitoring position through the recess in the base body.

In a further refinement of the aspects, the handling means can be configured to arrange a plurality of containers one after the other at the monitoring position for monitoring the respective container, in particular wherein the handling means is configured to handle a plurality of containers, in particular a row of containers, simultaneously.

In particular, the control means can be configured to control the handling means in such a way that a plurality of containers are arranged one after the other individually at the monitoring position for monitoring the respective container. In this way, each container after freeze-drying can be monitored at the monitoring position by means of the monitoring device. The handling means can be designed to handle a plurality of containers simultaneously. In particular, the gripping device of the handling means can have a number of grippers corresponding to the number of containers to be handled. The grippers are preferably arranged next to each other in a row. The handling means can in particular be designed to handle a row of containers simultaneously. The receptacles of the carrier plate in the loading station can be arranged in rows on the carrier plate. Accordingly, the containers are then also arranged in rows when the containers are arranged in the receptacles of a carrier plate. The handling means can be configured to transfer in each case a row of containers to the carrier plate and insert them into the receptacles and/or to remove in each case a row of containers from the receptacles and transfer them away from the carrier plate. In particular, the control means can control the handling means in such a way that in each case a row of containers is monitored from the loading station to the monitoring position and the containers are arranged one after the other at the monitoring position. In this way, a plurality of containers, especially a row of containers, can be monitored quickly.

In a further refinement of the aspects, the handling means can be configured to transfer a container filled with the freeze-dried product from the loading station to the monitoring position.

In particular, the control means can be configured to control the handling means in such a way that the handling means transfers a container filled with the freeze-dried product from the loading station to the monitoring position. In this way, after freeze-drying, the container is transferred from the loading station directly to the monitoring position, where it is then monitored by means of the monitoring device. The container is thus monitored directly after freeze-drying, before it is further processed or transferred to other stations, such as processing or transfer stations. In this way, a defect can be detected immediately after freeze-drying. Defective containers can then be rejected or disposed of directly without being further processed.

In a further refinement of the aspects, the loading system may comprise a transfer station, wherein the monitoring device is arranged between the loading station and the transfer station, in particular wherein the monitoring position is arranged between the loading station and the transfer station.

The handling means can be configured to transfer a container between the loading station and the transfer station. The transfer station can be used to transfer the container to downstream processing stations. Because the monitoring device is arranged between the loading station and the transfer station, the container can be monitored at the monitoring position on the transfer route between the loading station and the transfer station. In particular, containers are only transferred to the transfer station when the monitoring has shown that they are free of defects. Ensuring that only containers without defects are transferred to the transfer station prevents defective containers from being able to reach the transfer station or downstream processing stations.

In a further refinement of the method, the method may further comprise the following step:
first transferring the container from a loading station, for loading and/or unloading a freeze dryer with containers, to the monitoring position, by means of the handling means.

As explained previously, this allows a defect to be detected immediately after freeze-drying without the container being further processed.

In a further refinement of the fourth aspect, the container can be arranged, in the step of arranging, by means of the handling means, such that a bottom of the container faces the camera system, in particular wherein the bottom of the container is shown in the captured image.

As explained previously, in this way the bottom of the container is shown in the captured image. This allows the bottom of the container to be checked for defects.

In a further refinement of the fourth aspect, the method may further comprise the following step:
illuminating the container at the monitoring position by means of an illumination device, at least while the camera system captures the image of the container at the monitoring position, wherein the illumination device is arranged in the vertical direction below the monitoring position, in particular wherein the illumination device illuminates the bottom of the container at the monitoring position.

As previously explained, illuminating the container at the monitoring position ensures that the camera system can capture images under defined lighting conditions and with better illumination of the container. This allows defects in the captured image to be better identified.

In a further refinement of the fourth aspect, the container may have an annular projection on a bottom of the container, wherein it is determined, based on the captured image, whether the annular projection is complete, wherein it is determined that the container has a defect if the annular projection is not complete.

The control means can determine in the captured image whether the annular projection of the bottom, shown therein, is complete. The control means can then determine that the container has a defect if the annular projection is not complete. Accordingly, the control means can also determine that the container has no defect if the annular projection is complete. As previously explained, this improves the monitoring of the container.

In a further refinement of the fourth aspect, the method may further comprise the following step:
second transferring of the container from the monitoring position to a transfer station by means of the handling means when the container has no defect.

In particular, the handling means can transfer the monitored container to the transfer station when the monitoring has shown that the container has no defect. As previously explained, as a result only containers without defects are transferred to the transfer station. This prevents defective containers from reaching the transfer station or downstream processing stations.

In a further refinement of the fourth aspect, the method may further comprise the following step:
third transferring of the container from the monitoring position to a disposal device by means of the handling means if the container has a defect.

In particular, the handling means may transfer the monitored container to the disposal device if the monitoring reveals that the container has a defect. As previously explained, in this way defective containers are rejected after freeze-drying. This prevents defective containers from being further processed and, in particular, from reaching downstream processing stations.

It is understood that the features mentioned above and those to be explained below can be used not only in the combination specified in each case but also in other combinations or on their own without departing from the scope of the present invention.

### DRAWINGS

Exemplary embodiments are shown in the drawings and are explained in more detail in the following description. In the drawings:

FIG. 1 is a schematic view of an embodiment of a monitoring device;

FIG. 2 is a schematic view of a first embodiment of a freeze-dryer system;

FIG. 3 is an isometric view of a second embodiment of a freeze-dryer system;

FIG. 4 is a side view of the freeze-dryer system of FIG. 3;

FIG. 5 is a side view of a monitoring device of a loading system of the freeze-dryer system of FIG. 3 during the monitoring of a first container;

FIG. 6 is a side view of the monitoring device of FIG. 5 during the monitoring of a second container;

FIG. 7A is a side view of a container;

FIG. 7B is a cross-sectional view of the container of FIG. 7A;

FIG. 7C is a plan view of a bottom of the container of FIG. 7A;

FIG. 8A is a view of a bottom of a container with a crack as a defect;

FIG. 8B is a view of a bottom of a container with a gap as a defect; and

FIG. 9 is a schematic view of an embodiment of a method.

### DETAILED DESCRIPTION

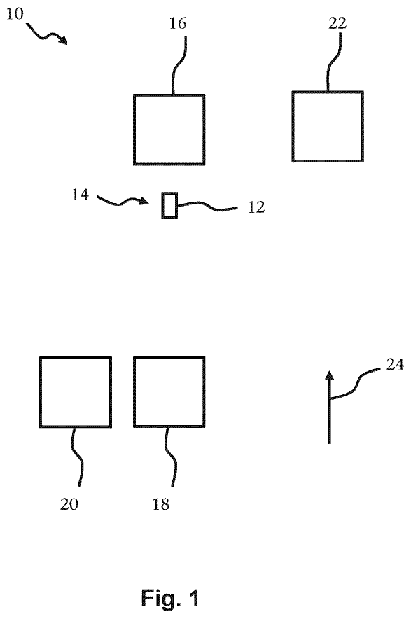

FIG. 1 shows a first embodiment of a monitoring device, denoted in its entirety by the reference sign 10. The monitoring device serves to monitor at least one container 12 at a monitoring position 14. The container 12 may be, for example, a vial, a carpule, a cylindrical ampoule, a bottle, a syringe, or the like. In particular, the container 12 can be a vial. The container 12 may preferably be cylindrical or have a circular cross-section. The shape of the container 12 can in particular be rotationally symmetrical with respect to an axis of symmetry. The container 12 is filled with a product. The product may preferably be a cosmetic or pharmaceutical product. The product is freeze-dried before monitoring.

The monitoring device 10 has a handling means 16. The handling means 16 is used to handle the container 12. In particular, the handling means 16 is configured to arrange the container 12 at the monitoring position 14. The handling means 16 can in particular transfer the container 12. For this purpose, the handling means 16 can, for example, grip the container 12 and move it in the gripped state. In particular, the handling means 16 can hold the container 12 at the monitoring position 14. For gripping and holding the container 12, the handling means 16 can, for example, have a gripping device.

The monitoring device 10 further comprises a camera system 18. The camera system 18 is configured to capture an image of the container 12 at the monitoring position 14. For image capture, the camera system 18 may, for example, comprise a camera or an optical sensor, in particular a CCD sensor or CMOS sensor. The camera system 18 is arranged in a vertical direction 24 below the monitoring position 14. The container is thus imaged from below by means of the camera system 18 at the monitoring position 14. In particular, a bottom of the container 12 may be shown in the captured image.

The monitoring device 10 may further comprise an illumination device 20. The illumination device 20 serves to illuminate the container 12 at the monitoring position 14. The illumination device is arranged in the vertical direction 24 below the monitoring position 14. In particular, the illumination device 20 can be configured to illuminate the bottom of the container 12 at the monitoring position 14. The illumination device 20 may comprise an annular light.

The monitoring device 10 further comprises a control means 22. The control means 22 can control the handling means 16, the camera system 18 and the illumination device 20. In particular, the control means 22 can control the handling of the containers 12 by the handling means 16, image capture by the camera system 18, and illumination by the illumination device 20. In particular, the control means 22 can control the handling means 16 such that the handling means 16 arranges the container 12 at the monitoring position 14. Furthermore, the control means 22 can control the camera system 18 such that the camera system 18 captures an image of the container 12 at the monitoring position 14. Furthermore, the control means 22 can control the illumination device 20 such that the container 12 is illuminated at the monitoring position 14 at least during image acquisition by the camera system 18. The control means 22 can in addition evaluate the captured image. In particular, the control means 22 can determine, on the basis of the captured image, whether the container 12 has a defect.

For this purpose, the control means 22 can, for example, have various subunits, each of which controls a component and/or a processing of data. For example, the control means 22 may have a regulation unit that controls the handling means 16, the camera system 18 or the illumination device 20. The regulation unit can, for example, send control commands to the respective components for controlling these components. Furthermore, the control means 22 can have a data processing unit which is configured to carry out the evaluation of images captured by the camera system 18. The data processing unit can, for example, determine on the basis of the captured image whether the container 12 has a defect.

The control means 22 may be connected to or comprise a non-volatile data memory in which a computer program is stored. In some embodiments, the control means 22 is a general-purpose computer, such as a commercially available personal computer running Windows®, Linux, or MacOS, and the computer program from the memory includes program code designed and configured to implement control and determination steps. In an alternative embodiment, the control means 22 is a logic circuit such as a field programmable gate array (FPGA), an application-specific integrated circuit (ASIC), a microcontroller, or any other suitable programmable electrical circuit. Control and determination steps can be implemented therein by means of the logic circuit. Any appropriate programming language or hardware description language may be used to implement the control and determination steps in the logic circuit, such as C, VHDL, and the like.

For monitoring the container 12, the container is first placed at the monitoring position 14 by means of the handling means 16. In this case, the container 12 can preferably be arranged in a defined orientation at the monitoring position 14. For example, the handling means 16 can arrange the container 12 at the monitoring position 14 such that a bottom of the container faces the camera system 18. An image of the container 12 at the monitoring position 14 is then captured by the camera system 18. Preferably, the bottom of the container 12 may be shown in the image. During image acquisition, the container 12 can be illuminated at the monitoring position 14 by means of the illumination device 20. The control means 22 can then determine, on the basis of the captured image, whether the container 12 has a defect. In particular, the container may have an annular projection on the bottom. The control means 22 may then be configured to determine, on the basis of the captured image, whether the annular projection is complete, wherein the control means 22 may determine that the container has a defect if the annular projection is not complete, and that the container has no defect if the annular projection is complete.

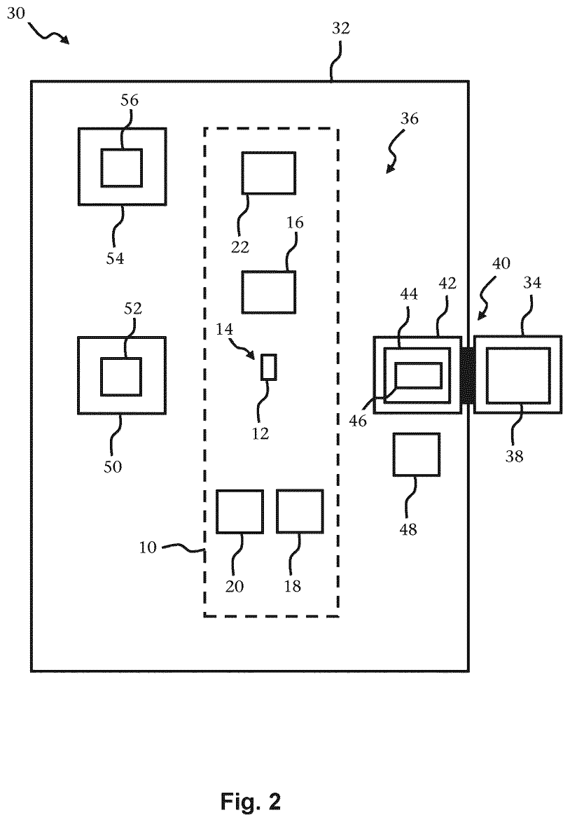

FIG. 2 shows a first embodiment of a freeze-dryer system, denoted in its entirety by the reference sign 30.

The freeze-dryer system 30 includes a freeze-dryer module 32, a freeze dryer 34 and a loading system 36. The loading system 36 is arranged within the freeze-dryer module 32. The loading system 36 comprises the monitoring device 10.

Containers 12 filled with a pharmaceutical or cosmetic product can be freeze-dried in the freeze dryer 34. The freeze dryer has one or more shelves 38. The containers 12 can be arranged on the shelves 38 for freeze-drying. The loading system 36 is used to load the freeze dryer 34 with the containers 12 and unload them. The freeze dryer 34 is arranged outside the freeze-drying module 32. The freeze-drying module 32 has a port 40. The freeze dryer 34 is arranged on the outside of the port. The freeze dryer 34 can be couplable to the port 40, in particular from the outside. The loading system 36 can load and unload the freeze dryer 34 via the port 40.

The loading system 36 has a loading station 42. The loading station 42 is arranged at the port 40. The loading station 42 has a loading area 44. One or more carrier plates 46 can be arranged on the loading area. The carrier plates 46 are used for loading the freeze dryer 34 with the containers 12 and unloading them. Each carrier plate 46 has a plurality of receptacles. The receptacles of the carrier plate are designed so that each receptacle can accommodate one container 12.

The loading system 36 further comprises a further handling means 48. The further handling means 48 is designed to insert the carrier plates 46 into the freeze dryer 34 or to remove them therefrom. For this purpose, the further handling means 48 can push a carrier plate 46 from the loading area 44 onto the storage area 38 or pull it from the storage area 38 back onto the loading area 44.

The loading system 36 further comprises a transfer station 50. The transfer station 50 is used to transfer containers 12, for example to downstream processing stations. The transfer station 50 may have a container holder 52. Containers 12 can be arranged in the container holder 52. The monitoring device 10 is arranged between the loading station 42 and the transfer station 50.

The loading system 36 further comprises a disposal device 54. Defective containers 12 can be disposed of in the disposal device 54. The disposal device 54 may have a collection container 56. Defective containers 12 can be collected in the collection container 56.

After freeze-drying, the containers 12 filled with the freeze-dried product are placed in the loading station 42. In particular, the containers 12 are then arranged in the receptacles of the carrier plate 46. The handling means 16 can be configured to transfer a container 12 filled with the freeze-dried product from the loading station 42 to the monitoring position 14. In particular, the handling means 16 can remove the containers 12 from the receptacles of the carrier plate 46 and then arrange or hold them one after the other at the monitoring position 14.

At the monitoring position 14, each container 12 is then monitored by means of the monitoring device 10. In particular, it is determined in this case whether the respective container 12 has a defect.

After monitoring, each monitored container 12 is transferred onward by means of the handling means 16. The handling means 16 may be configured to transfer the monitored container 12 to the transfer station 50 if the container 12 has no defect. In particular, the handling means 16 can insert the container 12 into a receptacle of the container holder 52 if the container 12 has no defect. The handling means 16 may be configured to transfer the monitored container 12 to the disposal device 54 if the container 12 has a defect. In particular, the handling means 16 can arrange the container 12 in the collection container 56 if the container 12 is defective.

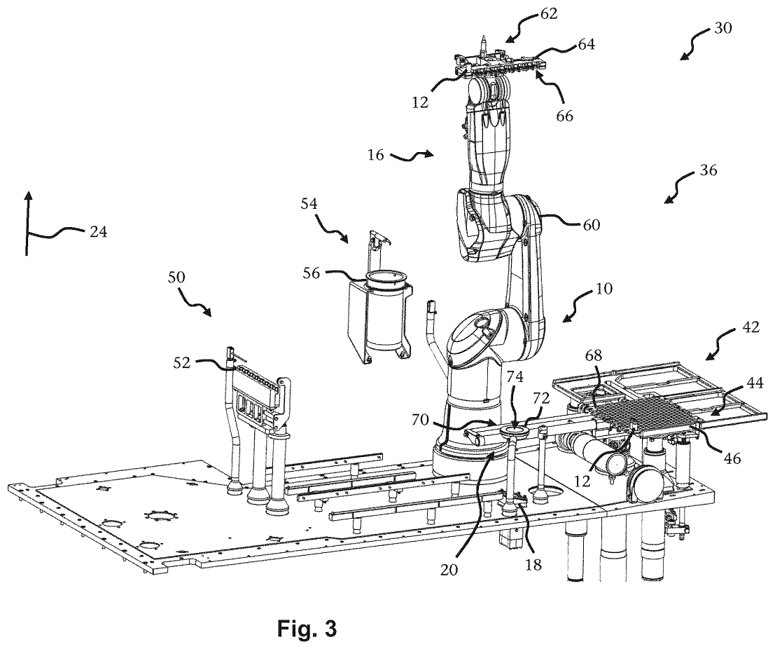

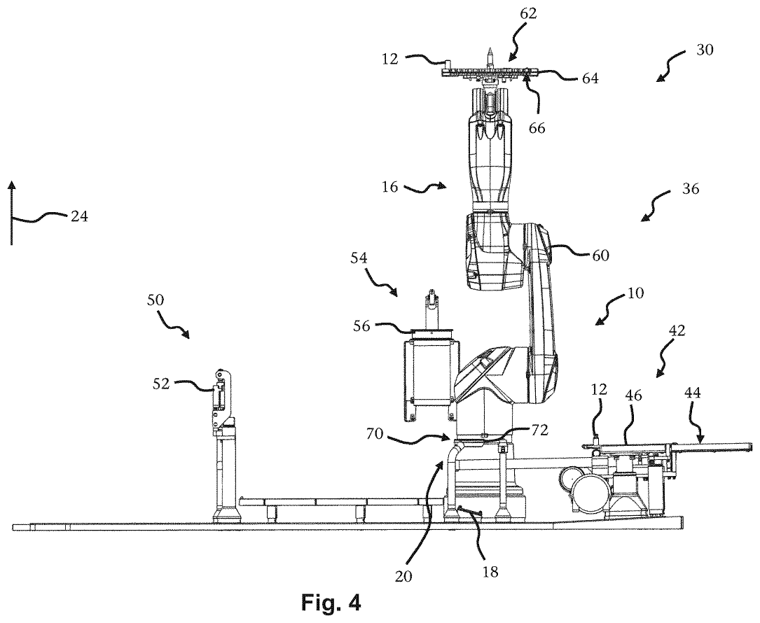

FIGS. 3 and 4 show a second embodiment of the freeze-dryer system 10. The freeze-dryer system of the second embodiment essentially corresponds to the freeze-dryer system 10 of the first embodiment shown in FIG. 2. Identical elements are denoted by the same reference signs and are not explained in more detail.

The handling means 16 is preferably designed as a handling robot. The handling means 16 has a multi-axis arm 60, an end effector 62 and a gripping device 64. The end effector 62 is arranged at one end of the arm 60. The handling means 16 may have a drive device for moving the arm 60. The gripping device 64 is arranged on the end effector 62. In particular, the end effector 62 carries the gripping device 64. By means of the gripping device 64, several containers 12 can be handled simultaneously. In particular, a row of containers 12 can be handled by means of the gripping device 64. For this purpose, the gripping device 64 has a plurality of grippers 66. The number of grippers 66 corresponds to the number of containers 12 to be handled. Each gripper 66 can grip and hold one container 12.

A carrier plate 46 is arranged on the loading area 44 of the loading station 42. The carrier plate has a plurality of receptacles 68. A container 12 can be arranged in each receptacle 68. In the representations in FIGS. 3 and 4, only two containers 12 are shown on the carrier plate 46. The receptacles 68 are arranged in rows on the carrier plate 46. Correspondingly, the containers 12 are also arranged in rows when the containers 12 are arranged in the receptacles 68. The number of grippers 66 can correspond to the number of receptacles 68. By means of the gripping device 64, in each case one row of containers 12 can then be picked up from the carrier plate. The control means 22 can control the handling means 16 such that the gripped containers 12 are arranged one after the other at the monitoring position 14.

The illumination device 20 has an annular light 70. The annular light 70 is arranged between the monitoring position 14 and the camera system 18. The annular light 70 has an annular base body 72 and a cylindrical recess 74 which extends through the base body 72. In particular, the recess 74 extends from a side of the base body 72 facing the monitoring position 14 to a side of the base body 72 facing the camera system 18. The camera system 18 and the annular light 70 are arranged such that the camera system 18 can capture the monitoring position 14 through the recess 74.

The base body 72 can have a plurality of lighting elements, in particular a plurality of light-emitting diodes. The lighting elements can be arranged around the recess 74, preferably evenly distributed or distributed peripherally at equal spacings. The lighting elements can in particular be arranged on a side of the base body 72 which faces the monitoring position 14.

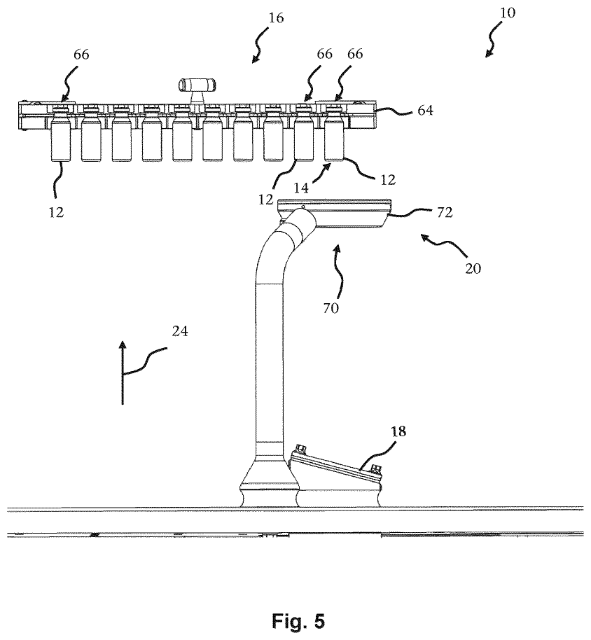

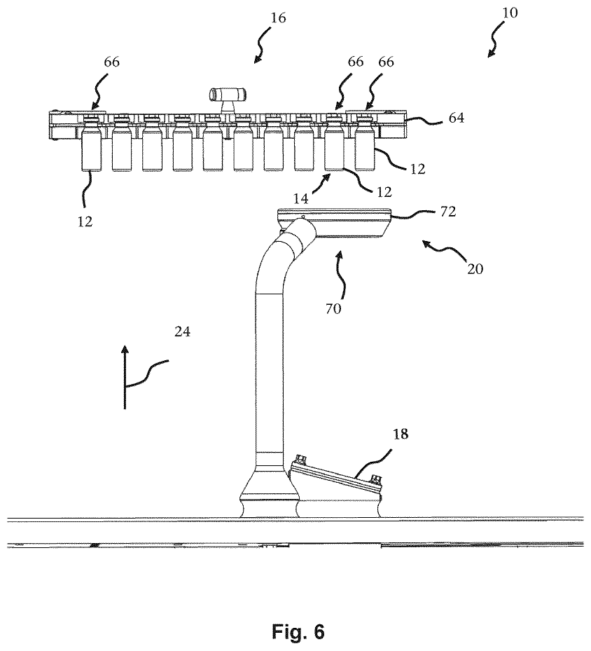

FIGS. 5 and 6 show how the handling means 16 arranges several containers 12 one after the other at the monitoring position for monitoring. As already explained above, the handling means 16 can handle or grip a number of containers 12 simultaneously by means of the grippers 66 of the gripping device 64. In FIG. 5, a first container 12 is arranged at the monitoring position 14. In FIG. 6, a second container 12 is arranged at the monitoring position 14.

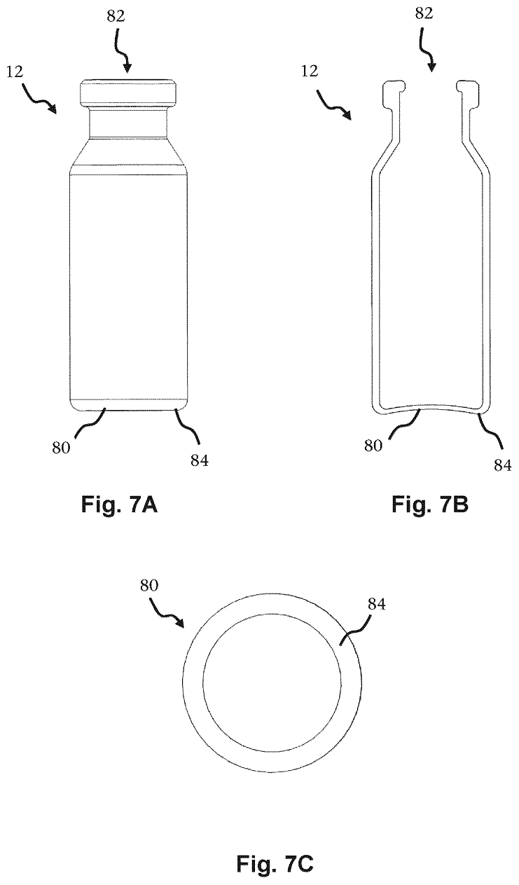

FIGS. 7A to 7C show an embodiment of the container 12. The container 12 has a bottom 80 and an opening 82. The bottom 80 and the opening 82 are arranged on opposite ends of the container 12. The container 12 has an annular projection 84 on the bottom 80.

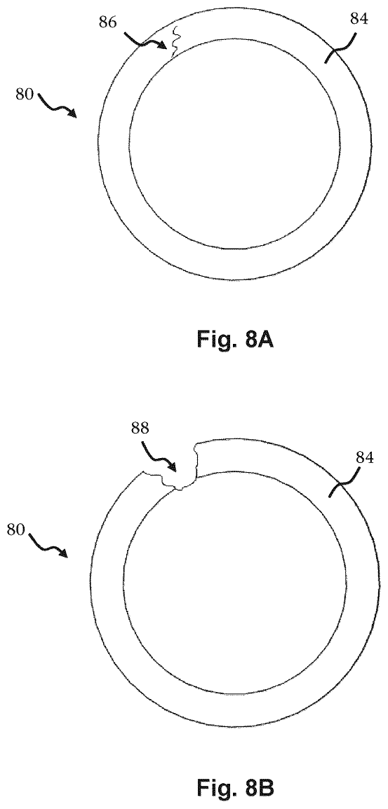

FIGS. 8A and 8B show two examples of defective containers 12 which have a defect on the bottom 80, in particular in the region of the annular projection 84.

In FIG. 8A, the bottom 80 has a crack 86 as a defect in the region of the annular projection 84. In FIG. 8B, the bottom 80 has a gap 88 as a defect in the region of the annular projection 84. The gap 88 may be a location on the bottom where a part of the bottom 80 has chipped off or broken away. The gap 88 can also be a hole in the bottom 80. In FIG. 7C, the bottom 80 of the container 12 is shown without any defect.

In the case of a container 12 without a defect in the region of the bottom 80, the annular projection 84 will generally be complete, whereas in a container with a defect in the region of the bottom 80, the annular projection 84 will generally be incomplete.

In order to check whether the container 12 has a defect, the completeness of the annular projection 84 can be checked. For this purpose, an image of the container 12 at the monitoring position 14 can be captured by means of the camera system, in which image the bottom 80 of the container 12 and in particular of the annular projection 84 of the container 12 are depicted. By evaluating the captured image, it can then be determined whether the annular projection 84 is complete. Defects such as a crack 86 or a gap 88 result in the annular projection 84 being incomplete. The evaluation can be carried out by means of the control means 22.

For monitoring the completeness of the annular projection 84, it can be determined, for example, whether the annular projection 84 shown in the captured image is closed and homogeneous, in particular circumferentially without interruptions. In particular, for this purpose an image region of the captured image in which the annular projection 84 is shown can be evaluated. Due to the arrangement of the container 12 at the monitoring position 14 in a vertical orientation, the position of the image of the annular projection 84 in the captured image and thus also of the corresponding image region can be known in advance.

The annular projection 84 can preferably be rotationally symmetrical with respect to an axis of symmetry of the container 12. The imaging of the annular projection 84 will thus also be substantially rotationally symmetric in the captured image if the annular projection 84 is not damaged or has no defect. For monitoring the completeness of the annular projection 84, for example individual segments of the annular projection 84 can be observed around the axis of symmetry, which segments are arranged successively around the axis of symmetry. Defects, such as a crack 86 or a gap 88, mean that not all segments will be imaged identically or homogeneously. If all segments are imaged essentially identically or homogeneously, the annular projection 84 is complete. If not all segments are imaged substantially identically or homogeneously, the annular projection 84 is not complete.

Alternatively, for monitoring the completeness of the annular projection 84, a comparison image can also be used, which shows a bottom 80 of a container 12 without a defect. On the basis of an image comparison between the captured image and the comparison image, it can then be determined whether the annular projection 84 is complete.

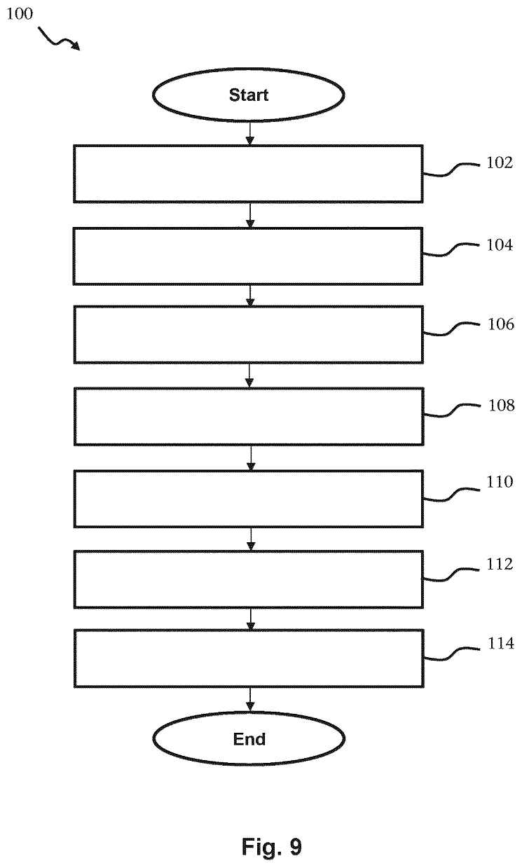

FIG. 9 shows an embodiment of a method, denoted in its entirety by the reference sign 100. The method 100 serves for monitoring at the monitoring position 14 at least one container 12 filled with a freeze-dried product. The method 100 can be carried out by means of the monitoring device 10 and/or by means of the loading system 36. The method 100 can be carried out in particular within the freeze-dryer system 30.

In a first, optional step 102 of the method 100, a container 12 is transferred from the loading station 42 to the monitoring position 14 by means of the handling means 16.

In a further step 104 of the method 100, the container 12 is arranged at the monitoring position 14 by means of the handling means 16. In this case, the container 12 can preferably be arranged such that the bottom 80 of the container 12 faces the camera system 18. In particular, the container 12 can be arranged in a vertical orientation at the monitoring position 14.

In a further step 106 of the method 100, an image of the container 12 at the monitoring position 14 is captured by the camera system 18. In particular, the bottom 80 of the container 12 may be imaged in the captured image.

In a further, optional step 108 of the method 100, the container 12 is illuminated at the monitoring position 14 by means of the illumination device 20. The illumination takes place at least during image capture by the camera system 18. In other words, the container 12 at the monitoring position 14 is illuminated by means of an illumination device 20, at least while the camera system 18 is capturing the image of the container 12 at the monitoring position 14. The illumination device 20 is arranged in the vertical direction below the monitoring position 14. In particular, the illumination device 20 can illuminate the bottom 80 of the container 12 at the monitoring position 14.

In a further step 110 of the method 100, it is determined on the basis of the captured image whether the container has a defect. The determination can be carried out by means of the control means 22. In particular, the container 12 may have the annular projection 84 on the bottom 80. On the basis of the captured image, it can then be determined whether the annular projection 84 is complete. If the annular projection 84 is not complete, it is determined that the container 12 has a defect. If the annular projection 84 is complete, it will be determined that the container 12 has no defect.

In a further, optional step 112 of the method 100, the container 12 is transferred by means of the handling means 16 from the monitoring position 14 to the transfer station 50 if the container 12 has no defect.

In a further, optional step 114 of the method 100, the container 12 is transported by means of the handling means 16 from the monitoring position 14 to the disposal device 54 if the container 12 has a defect.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance, “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A monitoring device for monitoring at least one container, filled with a freeze-dried product, at a monitoring position, comprising a handling means, a camera system and a control means, wherein the camera system is arranged in a vertical direction below the monitoring position; the handling means is configured to arrange the container at the monitoring position; the camera system is configured to capture an image of the container at the monitoring position; and the control means is configured to determine, on the basis of the captured image, whether the container has a defect.

2. The monitoring device according to claim 1, wherein the handling means is configured to transfer the container to a transfer station when the container has no defect.

3. The monitoring device according to claim 1, wherein the handling means is configured to transfer the container to a disposal device when the container has a defect.

4. The monitoring device according to claim 1, wherein the handling means is configured to arrange the container at the monitoring position in a defined orientation.

5. The monitoring device according to claim 1, wherein the container has a bottom; and the handling means is configured to arrange the container at the monitoring position such that its bottom faces the camera system.

6. The monitoring device according to claim 1, wherein the control means is configured to determine, on the basis of the captured image, whether the bottom of the container has a defect.

7. The monitoring device according to claim 1, wherein the container has an annular projection on the bottom; the control means is configured to determine, on the basis of the captured image, whether the annular projection is complete; and the control means is configured to determine that the container has a defect when the annular projection is not complete.

8. The monitoring device according to claim 1, wherein the monitoring device further comprises an illumination device for illuminating the container at the monitoring position; the illumination device is arranged in the vertical direction below the monitoring position; and the illumination device is configured to illuminate the bottom of the container at the monitoring position.

9. The monitoring device according to claim 8, wherein the illumination device is designed as an annular light.

10. The monitoring device according to claim 1, wherein the handling means is designed to arrange a plurality of containers one after the other individually at the monitoring position for checking the respective container.

11. The monitoring device according to claim 10, wherein the handling means is designed to handle a plurality of containers simultaneously.

12. A loading system for a freeze dryer, comprising a loading station for loading the freeze dryer with containers filled with a pharmaceutical or cosmetic product and/or unloading the same, and a monitoring device for monitoring at least one container, filled with a freeze-dried product, at a monitoring position, wherein the monitoring device has a handling means, a camera system and a control means; the camera system is arranged in a vertical direction below the monitoring position; the handling means is configured to arrange the container at the monitoring position; the camera system is configured to capture an image of the container at the monitoring position; and the control means is configured to determine, on the basis of the captured image, whether the container has a defect.

13. The loading system according to claim 12, wherein the handling means is configured to transfer a container filled with the freeze-dried product from the loading station to the monitoring position.

14. The loading system according to claim 12, wherein the loading system has a transfer station; and the monitoring device is arranged between the loading station and the transfer station, wherein the monitoring position is arranged between the loading station and the transfer station.

15. A freeze-dryer system, comprising a freeze dryer and a loading system, wherein the loading system comprises a loading station for loading the freeze dryer with containers filled with a pharmaceutical or cosmetic product and/or unloading the same, and a monitoring device for monitoring at least one container, filled with a freeze-dried product, at a monitoring position; the monitoring device has a handling means, a camera system and a control means; the camera system is arranged in a vertical direction below the monitoring position; the handling means is configured to arrange the container at the monitoring position; the camera system is configured to capture an image of the container at the monitoring position; and the control means is configured to determine, on the basis of the captured image, whether the container has a defect.

16. A method for monitoring at least one container filled with a freeze-dried product at a monitoring position, wherein a camera system is arranged in a vertical direction below the monitoring position, the method comprises the following steps:
arranging the container at the monitoring position by means of a handling means;
capturing an image of the container at the monitoring position by means of the camera system; and
determining, on the basis of the captured image, whether the container has a defect.

17. The method according to claim 16, wherein the method further comprises the following step:
first transferring of the container from a loading station, for loading a freeze dryer with containers and/or unloading the same, to the monitoring position, by means of the handling means.

18. The method according to claim 16, wherein the arranging step further comprises arranging the container, by means of the handling means, such that a bottom of the container faces the camera system, and the bottom of the container is imaged in the captured image.

19. The method according to claim 16, wherein the method further comprises the following step:
illuminating the container at the monitoring position by means of an illumination device, at least while the camera system is capturing the image of the container at the monitoring position; the illumination device is arranged in the vertical direction below the monitoring position; and the illumination device illuminates the bottom of the container at the monitoring position.

20. The method according to claim 16, wherein the container has an annular projection on a bottom of the container; it is determined, on the basis of the captured image, whether the annular projection is complete; and it is determined that the container has a defect when the annular projection is not complete.

21. The method according to claim 16, wherein the method further comprises the following step:
second transferring of the container from the monitoring position to a transfer station by means of the handling means when the container has no defect.

22. The method according to claim 16, wherein the method further comprises the following step:
third transferring of the container from the monitoring position to a disposal device by means of the handling means when the container has a defect.
